(19) United States
(12) Patent Application Publication
(10) Pub. No.: US 2017/0280889 A1
(43) Pub. Date: Oct. 5, 2017

(54) OFFICE CHAIR SYSTEM AND METHOD FOR ADJUSTING AND USING AN OFFICE CHAIR SYSTEM

(71) Applicant: LOGICDATA Electronic & Software Entwicklungs GmbH, Deutschlandsberg (AT)

(72) Inventor: Walter KOCH, Schwanberg (AT)

(21) Appl. No.: 15/508,095

(22) PCT Filed: Aug. 7, 2015
(86) PCT No.: PCT/EP2015/068287

§ 371 Date: Mar. 1, 2017

(30) Foreign Application Priority Data
Sep. 1, 2014 (DE) 10 2014 112 548.7

(51) Int. Cl. A47C 31/12; G05B 19/048

(52) U.S. Cl. CPC A47C 31/126; G05B 19/048; G05B 2219/25317

(57) ABSTRACT

An office chair system has an office chair with adjustment elements for changing positions of elements of the office chair, a sensor element, a calculation unit coupled to the latter and to the adjustment elements, as well as an operating element coupled thereto. The adjustment elements are configured to detect contacts and actuations of components of the adjustment elements and to generate an adjustment signal based thereon. The sensor element is configured to determine the positions of the elements and a posture of a user and to generate a position signal based thereon. The calculation unit is configured to generate a first feedback signal based on the position signal, which contains information about a proposed change of the positions. One of the components is assigned to the proposed change. The calculation unit is configured to verify a contact or actuation of the assigned component and to generate a second feedback signal based thereon. The operating element is configured to output the first and second feedback signals.

### BACKGROUND OF THE INVENTION

The invention relates to an office chair system, in particular an office chair system including an adjustable office chair, and to a method for adjusting and using such an office chair system. Here and in the following, a chair can always be an arm chair as well.

Office chairs such as work place chairs with adjustable elements have been available for a longer time. Depending on the configuration, such office chairs offer various options for adjusting the seat height, the height of arm rests, the inclination of the back rest and so on, for example. However, knowledge of users associated with ergonomics in the use of adjustable office chairs can be incomplete. Moreover, the individual posture of the user, even if the office chair is advantageously adjusted in terms of ergonomics, can be unfavorable in terms of ergonomics, which may result in potential advantages of the adjustable office chair not being used.

### SUMMARY OF THE INVENTION

The present disclosure provides an improved concept for an office chair system having an adjustable office chair as well as for the use and/or adjustment of this chair, by means of which a user, in particular a user lacking profound knowledge of ergonomics, can adjust and/or use the office chair in an optimum manner.

According to the improved concept, an adjustment of the office chair and/or a change of his or her posture is proposed to a user on the basis of his or her posture and positions of elements of an office chair. Thus, the user may be instructed to adjust and/or use the office chair in an optimum manner.

An office chair system according to the improved concept includes an office chair, sensor means, e.g. one or more sensor elements, as well as at least one calculation unit coupled with the sensor means. The sensor means are configured to determine the positions of the elements of the office chair and/or a posture of a user of the office chair and to generate a position signal based on the determination. The calculation unit is configured to generate a first feedback signal based on the position signal. The first feedback signal may contain information about a proposed adjustment of a posture of the user and/or a proposed change of the positions of the elements of the office chair, for example.

In various embodiments, the office chair system further includes an operating element coupled with the calculation unit, which is configured to output the first feedback signal, e.g. to the user.

In further embodiments, the office chair includes adjustment means or adjustment elements for changing the positions of elements of the office chair. Here, the adjustment means are configured to detect a contact and/or actuation of one of at least two components of the adjustment means and to generate an adjustment signal based upon the detection. For example, the components of the adjustment means are configured as levers or switches, which are arranged at the office chair, for example.

In such embodiments, the first feedback signal may contain information about a proposed change of the positions of the elements of the office chair. Furthermore, at least one of the at least two components can be assigned to the proposed change.

For example, the calculation unit is further configured to verify a contact and/or an actuation of the component assigned to the change by means of the adjustment signal and to generate a second feedback signal based on the verification. For example, the operating element is configured then to output the second feedback signal to the user, for example.

In embodiments, in which the sensor means are configured to determine the posture of the user, the posture can directly or indirectly be determined or influenced by the positions of the elements of the office chair. Alternatively, the posture may also be determined or influenced regardless of the positions of the elements. A seat height, a height of a backrest of the office chair, an inclination angle of the backrest of the office chair, a height and/or an inclination of arm rests of the office chair, a seat depth and other positions of the above or further elements may be considered as positions of the elements, for example. In this case, the further positions and/or the further elements depend on the specific configuration of the office chair.

Throughout the various embodiments, the calculation unit and the operating element are in each case connected to the adjustment means and the sensor means in a wired or wireless manner. Just as well, the calculation unit and the operating element may be coupled to one another in a wired or wireless manner.

The output of the first and the second feedback signal by means of the operating element can be effected via optical, acoustical or haptic signals or instructions or a series of instructions, for example. In preferred embodiments, the first feedback signal includes information to the user as to which elements of the office chair should be adjusted in which order and in which manner in order to achieve, for example, an ergonomically better suited posture or sitting position.

Alternatively, or additionally, the first feedback signal may also indicate to the user that he or she could or should change his or her position for an ergonomically better posture or sitting position, without having to change the elements of the office chair. In such an application, the information about a proposed change of the position of the elements of the office chair is optional, for example. Furthermore, in such a case, the adjustment means are not necessarily configured to detect the contact and/or actuation of a component and generate the adjustment signal.

For example, the second feedback signal allows indicating to the user whether he or she contacts or actuates the correct component of the adjustment means. The user can thereby be instructed to operate the office chair in a correct and advantageous manner, for example by optical, acoustical or haptic signals.

In various embodiments of the office chair system, the operating element is designed as a personal computer or as a mobile communication device.

Mainly a smartphone, a cell phone, a tablet computer, a personal digital assistant, PDA, and a different portable computer are suitable as a mobile communication device.

In at least one embodiment of the office chair system, the operating element includes the calculation unit. In at least one further embodiment, the office chair includes the calculation unit.

In various embodiments of the office chair system, the components of the adjustment means are designed as levers and/or switches. Furthermore, the components have touch-sensitive sensors, which allow the detection of a contact of the respective component. Alternatively, or in addition, the components of the adjustment means may have pressure-sensitive sensors, which allow the detection of an actuation of the respective component.

As used herein, touch-sensitive sensors are to be understood as sensors that detect a contact or merely an object approaching the sensor. Pressure-sensitive sensors are to be understood as, for example, switches, hold-to-run controls, push-buttons, or click switches, which detect an actuation of the components through dragging or pushing on the component or through any other action to the component. In this case, actuation of the component is to be understood as not necessarily a complete actuation of the component, for example a complete push of a button or complete pull of a lever, but in particular also a partial actuation of the respective component.

In at least one embodiment of the office chair system, the touch-sensitive sensors are formed as capacitive sensors.

In various embodiments of the office chair system, the sensor means include external sensor means, which are arranged in or on the operating element and which are configured to determine or partly determine the posture of the user.

Such external sensor means may include inclination sensors, distance sensors, position sensors or further sensors. In such embodiments, the user may set, change or adjust the elements of the office chair, for example by positioning the operating element correspondingly, e.g. a mobile communication device, and by using the output of the feedback signal. Positioning of the operating element may include a holding of the operating element in a certain fashion or placing the operating element in a certain location, e.g. of the office chair or the body of the user. Alternatively or additionally, a posture of the user can be adapted, in particular improved, by means of the external sensor means, for example by using the feedback signals, without effecting a change to the elements of the office place.

In at least one embodiment of the office chair system, the calculation unit is configured to generate ergonomics data based on the position signal and to generate the first feedback signal based on a comparison between the ergonomics data and the reference data.

The reference data is stored in the calculation unit or the operating element, for example. Alternatively, the operating element or the calculation unit are configured to retrieve the reference data from a network, e.g. an intranet or an internet. In this case, the reference data describes an ergonomically optimal or advantageous setting of the positions of the elements of the office chair and may alternatively or additionally contain optimum, for example user-dependent, posture information. The ergonomics data essentially correspond to the position signal in a preprocessed form, so that a comparison with the reference data is possible, for example.

In at least one embodiment of the office chair system, the calculation unit is configured to generate the reference data based on physical properties of the user and/or a request of a reference database.

The physical properties of the user may contain size, weight, lengths of the legs, the shanks, the thighs, lengths of the arms, the upper arms, the forearms or further information about the physique of the user. Alternatively, or additionally, the physical properties of the user can as well be determined from more general information, e.g. the dress size such as a trouser size or shirt size. In such an embodiment, the calculation unit is configured to determine or estimate the physical properties of the user from the more general information by means of a request or comparison with data from a database or a table.

Various embodiments of the office chair system also include an image recording device, e.g. a camera or a 3D camera, which are configured and arranged in such a way that image data representing an image of the user of the office chair system can be recorded and transmitted to the operating element and/or the calculation unit. The calculation unit is further configured to determine the physical properties based upon the image data.

Furthermore, the calculation unit can be configured to identify the user by way of the image data and to thereupon retrieve physical properties or other data stored, for example, in a storage element of the office chair system.

In various embodiments of the office chair system, the sensor means include at least one further touch-sensitive sensor, which is configured to detect a physical contact or distance of the user with the further touch-sensitive sensor. The calculation unit is further configured to determine or partly determine the posture of the user based on the physical contact or distance.

In various embodiments, the sensor means include a plurality of further touch-sensitive sensors, which are arranged at different places of the office chair. For example, the further touch-sensitive sensors can be mounted in a backrest, a seating surface or arm rests of the office chair. For example, the touch-sensitive sensors make it possible to detect a wrong sitting posture of the user via contact points, e.g. of the back, the buttocks, or the thighs of the user at the backrest or the seating surface. As described with reference to the various embodiments of the office chair system, the detection of this wrong sitting posture can be taken into account for a further optimization of the sitting posture and a position of the user by outputting the feedback signals.

In various embodiments of the office chair system, the at least one further touch-sensitive sensor is configured as a capacitive sensor.

By means of the improved concept, a method for adjusting and using an office chair system is provided as well. The office chair system includes an office chair having adjustment means for changing positions of elements of the office chair.

The method includes a determination of positions of elements of the office chair system and/or a posture of a user. A position signal is generated based upon the determination. The method further comprises generating a first feedback signal based upon the position signal, wherein the first feedback signal contains information about a proposed change of the positions of the elements of the office chair and/or the posture of the user and at least one of at least two components of the adjustment means is assigned to the proposed change. Furthermore, the first feedback signal is output to the user. A second feedback signal is generated based upon a verification of a contact and/or an actuation of the components assigned to the change. Finally, the second feedback signal is output.

Pursuant to various embodiments of the method, the verification of the contact of the component assigned to the change is effected by means of touch-sensitive sensors and/or the verification of the actuation of the component assigned to the change is effected by means of pressure-sensitive sensors.

Further embodiments and implementations of the method result directly from the various embodiments of the office chair system.

### BRIEF DESCRIPTION OF THE DRAWINGS

The improved concept will hereinafter be explained in greater detail by means of exemplary embodiments with reference to the drawings. Components that are functionally identical or have an identical effect may be provided with identical reference numerals. Identical components or components of identical function may be explained only with respect to the figure that they were illustrated first in. The explanations are not necessarily repeated in the figures following said figure.

The figures show in:

FIG. 1 an embodiment of the office chair system;

FIG. 2 another embodiment of the office chair system;

FIG. 3 another embodiment of the office chair system; and

FIG. 4 an embodiment of the method for adjusting and using an office chair system by means of a flow chart.

### DETAILED DESCRIPTION

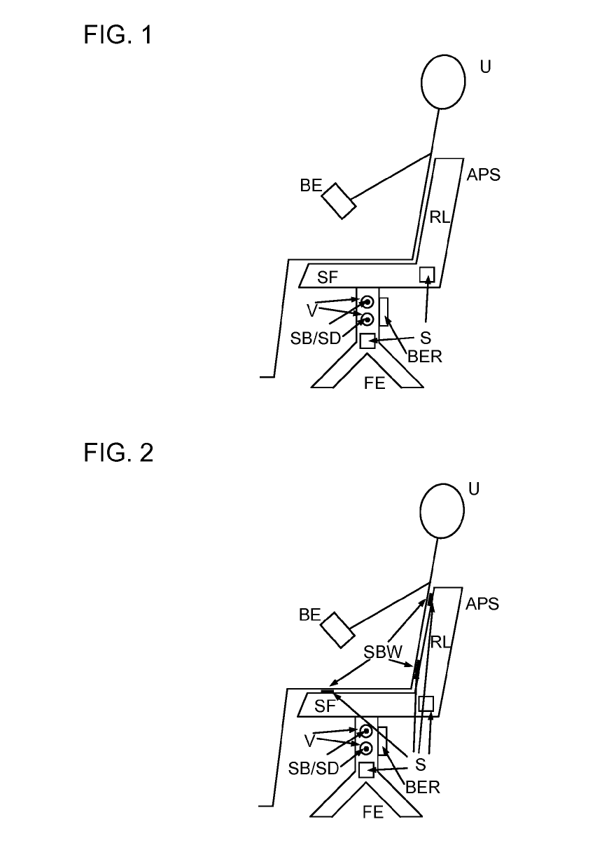

FIG. 1 shows an exemplary embodiment of the office chair system according to the improved concept. The office chair system includes an office chair APS having a seating surface SF, a backrest RL as well as a foot element FE. The office chair APS further includes adjustment means V, which are shown as unfilled circles here and which are arranged at the foot element FE of the office chair APS, for example. The adjustment means V include two components in this case. The adjustment means V include touch-sensitive sensors SB or pressure-sensitive sensors SD, shown as filled circles. In the case of touch-sensitive sensors SB, these sensors are configured as capacitive sensors, for example. The components of the adjustment means V per se can be configured as levers or switches, for example.

Furthermore, the office chair APS includes a calculation unit BER, which is arranged at the foot element FE. The office chair system further comprises sensor means S, which are arranged in the seating surface SF, e.g. close to the backrest RL, as well as in the foot element FE, in the illustrated exemplary embodiment. A schematically illustrated user U sits on the office chair APS and holds, for example, an operating element BE in his hands, for example a graphical operating element BE, which is also comprised by the office chair system. The operating element BE may be configured as a mobile communication device, e.g. as a smart phone or as a tablet computer. Alternatively, the operating element BE can be an accessory of the office chair APS and can also be integrated in the office chair APS, for example.

In the illustrated exemplary embodiment, the operating element BE is coupled with the calculation unit BER in a wireless manner. This can be effected via a Bluetooth data connection, via a radio connection, via a WLAN connection, via an infrared connection or via another suitable communication technology. The calculation unit BER per se is coupled with the sensor means S and the adjustment means V in a wired or a wireless manner. In alternative exemplary embodiments, the operating element BE can also be coupled with the calculation unit BER in a wired manner.

Of course, the specific physical arrangement of the adjustment means V, the sensor means S and the calculation unit BER is not obligatory as shown here schematically, but depends on the specific embodiment of the office chair APS, for example.

For example, the sensor means S are suitable to determine various positions of elements of the office chair APS, e.g. the seating surface SF and the backrest RL. For example, the sensor means S are configured to determine a height of the seating surface SF, corresponding of a sitting height, a horizontal position of the seating surface, e.g. corresponding a sitting depth, an inclination of the seating surface, a height position of the backrest RL and/or an inclination angle of the backrest RL. Depending on a specific configuration of the office chair APS, further positions of elements of the office chair APS can be determined by the sensor means S. For example, these may include positions, e.g. heights, inclinations and rotational angles of the armrests (not illustrated) as well as distances between armrests of the office chair APS.

The positions determined by the sensor means S may allow for drawing conclusions to a sitting position and/or a posture of the user U.

The calculation unit BER generates a position signal based on the positions determined by the sensor means S. For example, the calculation unit BER generates a first feedback signal based upon the position signal, which contains information about a proposed change of the position of the elements of the office chair APS and/or information about a proposed adjustment of the posture of the user U. Here, at least one of the components of the adjustment means is assigned to the proposed change of the positions. In a specific example, the proposed change could be an instruction to the user U as to adjust a position of one of the elements of the office chair APS, e.g. the height of the seating surface SF. The component assigned to the proposed change is the component of the adjustment means V, for example, which is to be actuated to be able to adjust the position of the element, e.g. the height of the seating surface SF.

For example, the first feedback signal is transmitted from the calculation unit BER to the operating element BE and output to the user U by the operating element BE in a suitable manner. For example, the output can be effected by graphically displaying the components of the adjustment means V on a display element, e.g. a screen, of the operating element BE. Here, the component assigned to the proposed change can be emphasized, for example. Alternatively, the output can be effected by displaying a text on the display element, via an acoustic output, such as a voice command or an alarm or warning signal, or via a haptic feedback, e.g. a vibration.

After that, the user U may touch or actuate one of the components of the adjustment means V with intent to change a position of a corresponding element of the office chair APS. The actuation may also correspond to a partial actuation or tipping on the component.

The touch-sensitive sensor SB or the pressure-sensitive sensor SD of the component of the adjustment means V touched or actuated by the user is configured to detect the contact or actuation. Based upon the detection, the adjustment means V generate an adjustment signal and transmit it to the calculation unit BER, for example. Here, the adjustment signal includes information as to which component of the adjustment means V was contacted or actuated by the user U. By means of the adjustment signal, the calculation unit BER verifies whether the component touched or actuated by the user U corresponds to the component assigned to the proposed change. In this way, the calculation unit BER is capable of determining whether the user is about to actuate the “correct” component and correspondingly adjust the “correct” position of the “correct” element of the office chair APS.

Based upon the verification, the calculation unit BER thereupon generates a second feedback signal and transmits it to the operating element BE. The operating element BE can output the second feedback signal to the user in a suitable manner then. The user U is thereby able to be informed whether he or she is about to actuate the “correct” component or whether he or she should actuate a different component.

One option of using the office chair system may consist in that the user U is instructed in the ways and manners described above to achieve an ergonomically optimal or improved posture or sitting position when he or she has a disadvantageous ergonomic posture or sitting position, for example. Thus, the calculation unit BER generates the first feedback signal, e.g. based upon a comparison between ergonomics data and reference data. For example, the ergonomics data are derived from the position signal by the calculation unit BER, for example.

For example, the reference data can be generated by the calculation unit BER based on physical properties of the user U. To that end, the user U may enter the physical properties in the operating element BE. The physical properties may include body size, body weight and/or dimensions of the arms, forearms, upper arms, legs, shanks and/or thighs or other body-related dimensions of the user U. Alternatively or in combination with the input of the physical data, the user may also enter in the operating element BE general body-related data such as a dress size of the user U. Then, for example, the operating element BE is capable of calculating, estimating or completing the physical properties from the input of the general body-related data. For the generation of the reference data, the calculation unit BER may alternatively or additionally request data from a reference database.

Alternatively, or additionally, the physical properties of the user U can be generated by the calculation unit BER based on image data, which illustrate an image of the user U. In corresponding embodiments, the office chair system further comprises a camera, e.g. 3D camera, or any other image recording device (not shown). For example, this device is arranged or configured at the office chair APS or an associated work place, e.g. a desk, so that it can generate the image data and transmit it to the calculation unit BER.

In various embodiments, the office chair system further comprises a storage element, which is coupled at least with the calculation unit BER. In the storage element, for example, the physical properties of the user U, the reference data and/or other information can be stored and held available for later use.

Alternative embodiments of the office chair system are based upon the embodiment shown in FIG. 1, in which the touch-sensitive sensors SB and the pressure sensitive sensors SD can be omitted. For example, in such an embodiment, the first feedback signal does not include any information about the proposed change of the positions of the elements of the office chair APS, but merely information about a proposed adjustment of the posture of the user U. The user U may then adapt his or her posture and/or sitting position in order to achieve an ergonomically improved posture or sitting position, for example. Thus, the necessity of the second feedback signal can be omitted.

In such embodiments, alternatively or additionally to the output via the operating element BE, the output of the first feedback signal can be effected via an element of the office chair APS as well. For example, the first feedback signal can be output as a haptic, optical and/or acoustical signal to the user U. In particular, the haptic signal may be designed as a vibration signal. In such embodiments, the operating element BE can be optional as well.

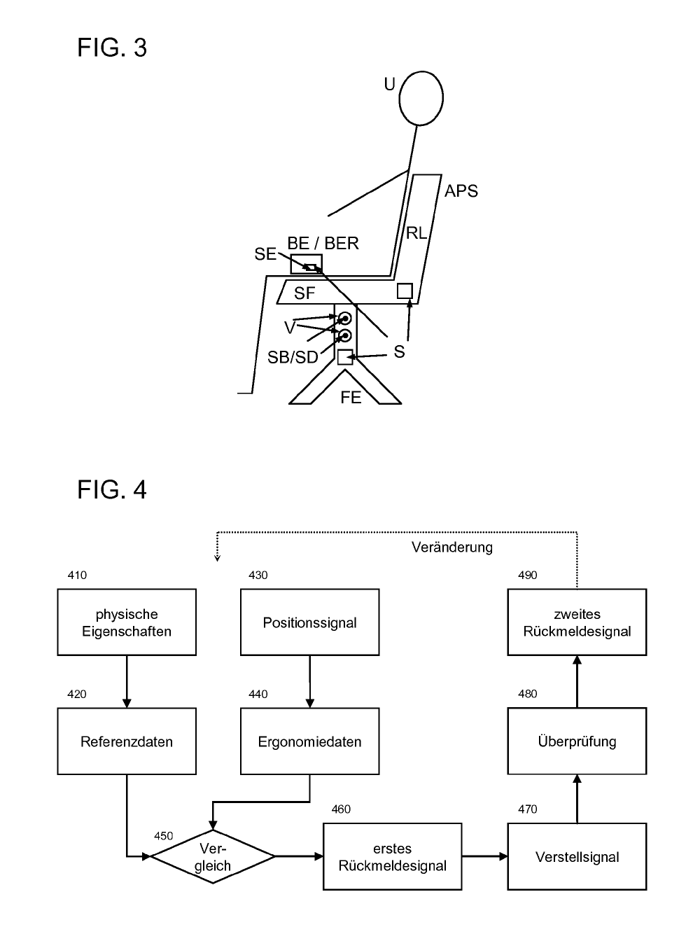

FIG. 2 shows another embodiment of the office chair system, which is based on the embodiment of FIG. 1. The senor means S additionally comprise further touch-sensitive or pressure-sensitive sensors SBW. The touch-sensitive or pressure-sensitive sensors SBW are configured as capacitive sensors, for example, and arranged at the seating surface SAF and the backrest RL of the office chair APS in the example shown. Three further touch-sensitive or pressure-sensitive sensors SBW can be seen in FIG. 3. However, more than three of such sensors can be arranged at the backrest RL and the seating surface SF, some of which can not be seen since FIG. 3 is a side view.

The touch-sensitive or pressure-sensitive sensors SBW can detect a physical contact between the user U and the further touch-sensitive or pressure-sensitive sensors SBW, for example. In the case shown, the further touch-sensitive or pressure sensitive sensors SBW thereby detect a contact between the back, the buttocks, or the thighs of the user U and the backrest RS or the seating surface SF in an effective manner, for example.

In the exemplary embodiment shown, the calculation unit BER generates the position signal depending on, inter alia, the detection of the physical contact, for example. The physical contact, which has a correlation with the posture of the user U that does not or only partially depend in the position of the elements of the office chair APS, can therefore be considered in the generation of the first feedback signal. The output of the first feedback signal may then for example also contain instructions to the user U as to also effect a direct change of his or her posture or sitting position alternatively or additionally to a change of a position of an element of the office chair APS. As a result, such an office chair system allows further optimizing the ergonomic posture of the user U.

FIG. 3 shows another exemplary embodiment of the office chair system, which is based on the embodiment of FIG. 1. In the embodiment illustrated herein, the calculation unit BER is integrated in the operating element BE. Furthermore, the sensor means S comprise external sensor means SE, which are integrated in the operating element BE and which can determine or partially determine the posture of the user U. The external sensor means SE may include, integrated in the operating element BE, sensors such as inclination sensors, acceleration sensors, rotational sensor, magnetic field sensors, approximation sensors and/or magnetic field sensors, for example. The position signal can be generated in such an embodiment based on, in particular partially based on, the posture of the user U determined or partially determined by means of the external sensor means SE.

In FIG. 3, the operating element BE is located on a thigh of the user U, for example. For example, by means of an inclination sensor, which is included in the external sensor means S, these means may then determine an angle which is formed between the thighs of the user U and the horizontal, for example. In other examples, of course, positions or orientations of other extremities or body parts of the user U can be determined in this or a similar manner. This information may then be considered in the generation of the position signal and thus also in the generation of the ergonomics data, for example.

The first feedback signal can then be generated effectively in consideration of the posture of the user determined in the ways and manners described herein. This allows further optimizing the posture of the user U from an ergonomic point of view. In the example shown, the user U could be instructed to change the positions of the elements of the office chair APS and/or his or her posture in such a way that a horizontal orientation of the thigh results.

FIG. 4 shows an embodiment of the method for adjusting and using an office chair system according to the improved concept by means of a flow chart.

Physical properties of the user U are detected in block 410. For example, this is effected based upon the input of the physical data and/or more general information such as a dress size by the user U into the operating element BE or by taking image data representing an image of the user U. Reference data is generated from the physical data in block 420, for example. Alternatively or additionally, the reference data can also be generated by means of a request from a reference database.

In block 430, a position signal is generated according to one of the described embodiments of the office chair system or the method, for example. To that end, positions of elements of the office chair APS and/or information about the posture of the user U may be taken into account. In block 430, ergonomics data is generated based on the position signal in such a way that they are suitable for a comparison with the reference data. After that, the comparison of the ergonomics data and the reference data is effected in block 450.

In block 460, a first feedback signal is generated based upon the comparison and output to the user U. The first feedback signal contains information about a proposed change of the positions of the elements of the office chair APS and/or the posture of the user U. Furthermore, one of the components of the adjustment means V is assigned to the proposed change. For example, in reaction to displaying the first feedback signal, the user U may thereupon touch or actuate a component of the adjustment means V, for example, with intent to change a position of an associated element of the office chair APS.

The contact or actuation is detected and, after that, an adjustment signal is generated in block 470. In block 480, verification is made by means of the adjustment signal as to whether the component, which was touched or actuated by the user, corresponds to the component assigned to the proposed change. Based thereupon, a second feedback signal is generated in block 490 and output to the user U. The user U is informed thereby whether he or she is about to actuate the “correct” component and adjust the corresponding element, respectively.

After that, the user U may effect, for example, a change of the position of an element of the office chair APS and/or his or her posture and the method can be restarted.

An ergonomically optimized adjustment and use of an office chair can be achieved by means of an office chair system according to the improved concept.

In particular, an ergonomically optimal use of the office chair APS can also be achieved after an optimal adjustment. To that end, the office chair system may have a storage device, which contains information as to for how long the elements of the office chair APS have been in certain positions, for example. Then, the first feedback signal can be used to propose to the user changing the positions of the elements of the office chair or the posture at certain time intervals.

In addition to the first and second feedback signal, an acoustic or haptic feedback can be used to draw the attention of the user to an ergonomically unfavorable setting of the office chair or an ergonomically unfavorable posture, for example. The acoustic or haptic feedback, the latter being e.g. a vibration of an element of the office chair, can be initiated by the calculation unit, for example.

1. Office chair system, comprising
an office chair;
a sensor element configured to determine positions of elements of the office chair and/or a posture of a user and to generate a position signal based on the determination; and
at least one calculation unit coupled to the sensor element, configured to generate a first feedback signal based on the position signal.

2. Office chair system according to claim 1, further comprising an operating element coupled to the calculation unit, which is configured to output the first feedback signal.

3. Office chair system according to claim 2, wherein the office chair comprises adjustment elements coupled with the calculation unit for changing the positions of the elements of the office chair, the adjustment elements configured to detect a contact and/or an actuation of one of at least two components of the adjustment elements and to generate an adjustment signal based on the detection, and wherein
the first feedback signal contains information about a proposed change of the positions of the elements of the office chair;
one of the at least two components is assigned to the proposed change;
the calculation unit is configured to verify a contact and/or an actuation of the components assigned to the change and to generate a second feedback signal based on the verification; and
the operating element is configured to output the second feedback signal.

4. Office chair system according to one of claims 1 to 3, wherein the operating element is configured as a mobile communication device.

5. Office chair system according to one of claims 2 to 4, wherein the operating element or the office chair includes the calculation unit.

6. Office chair system according to one of claims 3 to 5, wherein the at least two components of the adjustment elements
are configured as levers and/or switches;
have touch-sensitive sensors, which permit the detection of a contact of the respective component; and/or
have pressure-sensitive sensors, which permit the detection of an actuation of the respective component.

7. Office chair system according to claim 6, in which the touch-sensitive sensors are configured as capacitive sensors.

8. Office chair system according to one of claims 2 to 7, wherein the sensor element includes an external sensor element, which is arranged in or on the operating element and which is configured to determine or partly determine the posture of the user.

9. Office chair system according to one of claims 1 to 8, wherein the calculation unit is configured to generate ergonomics data based on the position signal and to generate the first feedback signal based on a comparison between the ergonomics data and the reference data.

10. Office chair system according to claim 9, wherein the calculation unit is configured to generate the reference data based on physical properties of the user and/or a request of a reference database.

11. Office chair system according to claim 10, further comprising an image recording device which is arranged and configured in such a way that image data, which represent an image of a user of the office chair system, can be recorded and transmitted to the calculation unit and wherein the calculation unit is configured to determine the physical properties based on the image data.

12. Office chair system according to one of claims 1 to 11, wherein the sensor element includes at least one further touch-sensitive or pressure-sensitive sensor, which is configured to detect a physical contact of the user with the further touch-sensitive or pressure-sensitive sensor and wherein furthermore the calculation unit is configured to generate the position signal depending on the detection.

13. Office chair system according to claim 12, wherein the further touch-sensitive or pressure-sensitive sensor is configured as a capacitive sensor.

14. Method for adjusting and using an office chair system including an office chair having adjustment elements for changing positions of elements of the office chair, the method comprising
determining positions of elements of the office chair and/or a posture of a user;
generating a position signal based on the determination;
generating a first feedback signal based on the position signal, wherein the first feedback signal contains information about a proposed change of the positions of the elements of the office chair and/or the posture of the user and one of at least two components of the adjustment elements is assigned to the proposed change;
outputting the first feedback signal;
generating a second feedback signal based on a verification of a contact and/or an actuation of the component assigned to the change; and
outputting the second feedback signal.

15. Method according to claim 14, wherein verifying the contact of the component assigned to the change is effected by way of touch-sensitive sensors.

16. Method according to claim 14, wherein verifying the actuation of the component assigned to the change is effected by way of pressure-sensitive sensors.
